(19) United States
(12) Patent Application Publication
(10) Pub. No.: US 2026/0073411 A1
(43) Pub. Date: Mar. 12, 2026

(54) INFORMATION PROCESSING SYSTEM, INFORMATION PROCESSING METHOD, AND RECORDING MEDIUM

(71) Applicant: NEC Corporation, Tokyo (JP)

(72) Inventors: Yudai YAMAGUCHI, Tokyo (JP); Izumi KUWATA, Tokyo (JP); Miki TANAKA, Tokyo (JP); You IWAKAMI, Tokyo (JP)

(73) Assignee: NEC Corporation, Tokyo (JP)

(21) Appl. No.: 19/311,431

(22) Filed: Aug. 27, 2025

(30) Foreign Application Priority Data
Sep. 9, 2024 (JP) 2024-155194

(51) Int. Cl. G06Q 30/0202; G06Q 30/0201

(52) U.S. Cl. CPC G06Q 30/0202; G06Q 30/02013

(57) ABSTRACT

An information processing system includes an index acquisition unit that acquires product-specific indices for managing accuracy of demand prediction related to a product handled by an object company, an intra-company information acquisition unit that acquires intra-company information related to the product inside the object company, an extra-company information acquisition unit that acquires extra-company information related to the product outside the object company, and an interpretation example generation unit that generates, as an interpretation example of the product-specific indices, a sentence including an interpretation example based on the intra-company information and the extra-company information, by using a large language model.

This application is based upon and claims the benefit of priority from Japanese Patent Application No. 2024-155194, filed on September 9, 2024, the disclosure of which is incorporated herein in its entirety by reference.

### TECHNICAL FIELD

The present disclosure relates to an information processing system, an information processing method, and a recording medium.

### BACKGROUND ART

In recent years, it is important to perform demand prediction of products. For example, JP 2015-118412 A describes a technology of predicting demand for a component to be predicted by using an analysis model constructed based on past operation number data and operation time data related to a device having the component and the past delivery result number of the component.

### SUMMARY

An exemplary object of the present disclosure is to provide a technology of supporting analysis of an error of demand prediction for each product.

An information processing system according to an exemplary aspect of the present disclosure includes index acquisition means for acquiring product-specific indices for managing accuracy of demand prediction related to a product handled by an object company, intra-company information acquisition means for acquiring intra-company information related to the product inside the object company, extra-company information acquisition means for acquiring extra-company information related to the product outside the object company, and interpretation example generation means for generating, as an interpretation example of the product-specific indices, a sentence including an interpretation example based on the intra-company information and the extra-company information, by using a large language model.

An information processing method according to an exemplary aspect of the present disclosure includes index acquisition processing in which at least one processor acquires product-specific indices for managing accuracy of demand prediction related to a product handled by an object company, intra-company information acquisition processing in which the at least one processor acquires intra-company information related to the product inside the object company, extra-company information acquisition processing in which the at least one processor acquires extra-company information related to the product outside the object company, and interpretation example generation processing in which the at least one processor generates, as an interpretation example of the product-specific indices, a sentence including an interpretation example based on the intra-company information and the extra-company information, by using a large language model.

A non-transitory recording medium recording an information processing program according to an exemplary aspect of the present disclosure causes at least one processor to execute index acquisition processing of acquiring product-specific indices for managing accuracy of demand prediction related to a product handled by an object company, intra-company information acquisition processing of acquiring intra-company information related to the product inside the object company, extra-company information acquisition processing of acquiring extra-company information related to the product outside the object company, and interpretation example generation processing of generating, as an interpretation example of the product-specific indices, a sentence including an interpretation example based on the intra-company information and the extra-company information, by using a large language model.

According to an exemplary aspect of the present disclosure, there is provided an exemplary effect that a technology of supporting analysis of an error of demand prediction for each product can be provided.

### BRIEF DESCRIPTION OF THE DRAWINGS

FIG. 1 is a block diagram illustrating a configuration of an information processing system according to the present disclosure;

FIG. 2 is a flowchart illustrating a flow of an information processing method according to the present disclosure;

FIG. 3 is a block diagram illustrating a configuration of an information processing system according to the present disclosure;

FIG. 4 is a block diagram illustrating a configuration of an information processing device according to the present disclosure;

FIG. 5 is a block diagram illustrating a configuration of a user terminal according to the present disclosure;

FIG. 6 is a flowchart illustrating a flow of an information processing method according to the present disclosure;

FIG. 7 is a flowchart illustrating a detailed flow of alert screen generation processing according to the present disclosure;

FIG. 8 is a diagram illustrating an example of an alert screen according to the present disclosure;

FIG. 9 is a flowchart illustrating a detailed flow of product-specific analysis screen generation processing according to the present disclosure;

FIG. 10 is a diagram illustrating an example of a product-specific analysis screen according to the present disclosure; and

FIG. 11 is a block diagram illustrating a hardware configuration of a computer that functions as each of devices according to the present disclosure.

### EXAMPLE EMBODIMENT

Hereinafter, example embodiments of the present disclosure will be exemplified. However, the present disclosure is not limited to the following example embodiments, and various modifications can be made within a scope described in the claims. For example, example embodiments obtained by appropriately combining technologies (some or all of things or methods) adopted in the following example embodiments can also be included in the scope of the present disclosure. Example embodiments obtained by appropriately omitting some of the technologies adopted in the following example embodiments can also be included in the scope of the present disclosure. Effects mentioned in the following example embodiments are examples of effects expected in the example embodiments, and do not define extension of the present disclosure. In other words, example embodiments that do not provide the effects mentioned in the following example embodiments can also be included in the scope of the present disclosure.

### [First Example Embodiment]

A first example embodiment that is an example of the example embodiments of the present disclosure will be described in detail with reference to the drawings. The present example embodiment is a basic form of each example embodiment to be described below. An application range of each technology adopted in the present example embodiment is not limited to the present example embodiment. In other words, each technology adopted in the present example embodiment can also be adopted in another example embodiment included in the present disclosure within a range in which no particular technical problem occurs. Each technology illustrated in the drawings referred to for describing the present example embodiment can also be adopted in another example embodiment included in the present disclosure within a range in which no particular technical problem occurs.

### [Configuration of Information Processing System 1]

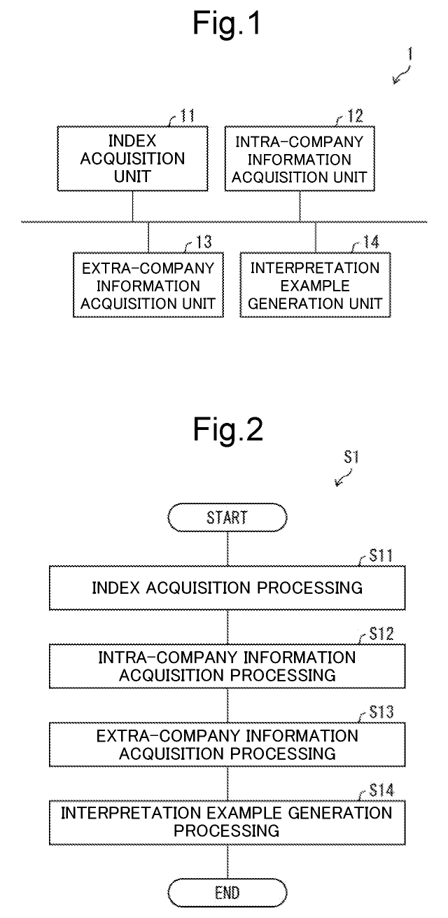

A configuration of an information processing system 1 will be described with reference to FIG. 1. FIG. 1 is a block diagram illustrating the configuration of the information processing system 1. As illustrated in FIG. 1, the information processing system 1 includes an index acquisition unit 11, an intra-company information acquisition unit 12, an extra-company information acquisition unit 13, and an interpretation example generation unit 14. The index acquisition unit 11 is an example of a configuration for achieving index acquisition means. The intra-company information acquisition unit 12 is an example of a configuration for achieving intra-company information acquisition means. The extra-company information acquisition unit 13 is an example of a configuration for achieving extra-company information acquisition means. The interpretation example generation unit 14 is an example of a configuration for achieving interpretation example generation means. The information processing system 1 may include a single device or may include a plurality of devices.

The index acquisition unit 11 acquires product-specific indices for managing accuracy of demand prediction related to a product handled by an object company. The object company is a company that handles products, and is a company that has introduced the information processing system 1 in order to manage accuracy of demand prediction related to the products for each product. The object company may be, for example, a manufacturer that manufactures the products, a retailer that sells the products to consumers, or an intermediate distributor (so-called wholesaler) that intermediates the products between the manufacturer and the retailer, but is not limited to these.

The demand prediction is to predict demand for a product. The demand prediction may be performed by a computer by using an optional technology, or may be manually performed by an expert. The accuracy of the demand prediction refers to how close a demand prediction value indicating a result of the demand prediction is to a demand result value indicating a result of the demand. The accuracy of the demand prediction is higher as an error of the demand prediction is smaller. The error of the demand prediction is a difference between the demand prediction value and the demand result value.

The product-specific indices for managing the accuracy of the demand prediction are indices that can be calculated based on the demand prediction value and/or the demand result value related to the product. The product-specific indices may include, for example, an index indicating an error rate of the demand prediction related to the product, an index indicating a tendency of an error of the demand prediction related to the product, and an index related to a channel in which the demand for the product occurs, but are not limited to these.

The intra-company information acquisition unit 12 acquires intra-company information related to a product inside an object company. For example, the intra-company information may include information related to activities performed by the object company with respect to the product, information related to another product of the same classification as the product, and the like.

The extra-company information acquisition unit 13 acquires extra-company information related to a product outside an object company. For example, the extra-company information may include general-purpose information independent of the object company with respect to the product.

The interpretation example generation unit 14 generates, as an interpretation example of product-specific indices, sentences including an interpretation example based on intra-company information and extra-company information, by using a large language model. For example, the interpretation example generation unit 14 may cause the interpretation example to be output from the large language model by generating a prompt including the product-specific indices, the intra-company information, and the extra-company information and inputting the prompt to the large language model. For example, the interpretation example generation unit 14 may additionally train the large language model by using the intra-company information and the extra-company information. In this case, the interpretation example generation unit 14 may cause the interpretation example to be output from the large language model by inputting the prompt including the product-specific indices to the additionally trained large language model. For example, the interpretation example generation unit 14 may add the intra-company information and the extra-company information to a knowledge base. In this case, the interpretation example generation unit 14 may cause the interpretation example to be output from the large language model by searching the knowledge base for information related to the product-specific indices and inputting a prompt including a search result and the product-specific indices to the large language model.

### (Effects of Information Processing System 1)

As described above, the information processing system 1 adopts the configuration including the index acquisition unit 11 that acquires product-specific indices for managing accuracy of demand prediction related to a product handled by an object company, the intra-company information acquisition unit 12 that acquires intra-company information related to the product inside the object company, the extra-company information acquisition unit 13 that acquires extra-company information related to the product outside the object company, and the interpretation example generation unit 14 that generates, as an interpretation example of the product-specific indices, a sentence including an interpretation example based on the intra-company information and the extra-company information, by using a large language model. Therefore, a user who refers to the interpretation example output from the information processing system 1 can know the interpretation example in consideration of the intra-company information and the extra-company information with respect to the product-specific indices for managing the accuracy of the demand prediction related to the corresponding product. As a result, according to the information processing system 1, it is possible to obtain an effect that analysis of the error of the demand prediction can be supported for each product.

### (Flow of Information Processing Method S1)

A flow of an information processing method S1 will be described with reference to FIG. 2. For example, in a case where the above-described information processing system 1 includes at least one processor, the at least one processor may execute the information processing method S1. FIG. 2 is a flowchart illustrating the flow of the information processing method S1. As illustrated in FIG. 2, the information processing method S1 includes index acquisition processing S11, intra-company information acquisition processing S12, extra-company information acquisition processing S13, and interpretation example generation processing S14.

In the index acquisition processing S11, at least one processor (for example, the index acquisition unit 11) acquires product-specific indices for managing accuracy of demand prediction related to a product handled by an object company. Details of the index acquisition processing S11 are as described for the index acquisition unit 11, and thus, detailed description of the index acquisition processing S11 will not be repeated.

In the intra-company information acquisition processing S12, at least one processor (for example, the intra-company information acquisition unit 12) acquires intra-company information related to the product inside the object company. Details of the intra-company information acquisition processing S12 are as described for the intra-company information acquisition unit 12, and thus, detailed description of the intra-company information acquisition processing S12 will not be repeated.

In the extra-company information acquisition processing S13, at least one processor (for example, the extra-company information acquisition unit 13) acquires extra-company information related to the product outside the object company. Details of the extra-company information acquisition processing S13 are as described for the extra-company information acquisition unit 13, and thus, detailed description of the extra-company information acquisition processing S13 will not be repeated.

In the interpretation example generation processing S14, at least one processor (for example, the interpretation example generation unit 14) generates, as an interpretation example of the product-specific indices acquired in the index acquisition processing S11, a sentence including an interpretation example based on the intra-company information and the extra-company information, by using a large language model. Details of the interpretation example generation processing S14 are as described for the interpretation example generation unit 14, and thus, detailed description of the interpretation example generation processing S14 will not be repeated.

### (Effects of Information Processing Method S1)

As described above, the information processing method S1 adopts the configuration including the index acquisition processing S11 in which at least one processor acquires product-specific indices for managing accuracy of demand prediction related to a product handled by an object company, the intra-company information acquisition processing S12 in which at least one processor acquires intra-company information related to the product inside the object company, the extra-company information acquisition processing S13 in which at least one processor acquires extra-company information related to the product outside the object company, and the interpretation example generation processing S14 in which at least one processor generates, as an interpretation example of the product-specific indices, a sentence including an interpretation example based on the intra-company information and the extra-company information, by using a large language model. Therefore, according to the information processing method S1, effects similar to those of the information processing system 1 can be obtained.

### [Second Example Embodiment]

A second example embodiment that is an example of the example embodiments of the present disclosure will be described in detail with reference to the drawings. Components that have the same functions as the components described in the above-described example embodiment are denoted by the same reference signs, and description of the components will be appropriately omitted. An application range of each technology adopted in the present example embodiment is not limited to the present example embodiment. In other words, each technology adopted in the present example embodiment can also be adopted in another example embodiment included in the present disclosure within a range in which no particular technical problem occurs. Each technology illustrated in each of the drawings referred to for describing the present example embodiment can also be adopted in another example embodiment included in the present disclosure within a range in which no particular technical problem occurs.

### (Configuration of Information Processing System 1A)

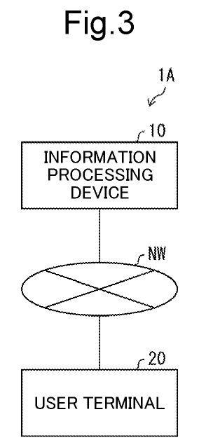

FIG. 3 is a block diagram illustrating a configuration of an information processing system 1A. The information processing system 1A is a system that supports analysis of an error of demand prediction. As illustrated in FIG. 3, the information processing system 1A includes an information processing device 10 and a user terminal 20. The information processing device 10 and the user terminal 20 are communicably connected via a communication line NW. Although a specific configuration of the communication line NW is not limited to the present example embodiment, the communication line NW is, as an example, a wireless local area network (LAN), a wired LAN, a wide area network (WAN), a public line network, a mobile data communication network, or a combination of these.

The information processing device 10 functions as a server that provides a service for analyzing an error of demand prediction for each product in an object company. For example, the information processing device 10 may be a stationary computer, but is not limited to this. The user terminal 20 is a terminal used by a user who uses the above service in the object company. The user terminal 20 may be, for example, a notebook personal computer, a smartphone, or a tablet, but is not limited to these. The user who uses the user terminal 20 may be, for example, a user who manages products. The user may also be a user who has little knowledge related to the demand prediction. The user may also be a user who has knowledge related to the demand prediction.

### (Configuration of Information Processing Device 10)

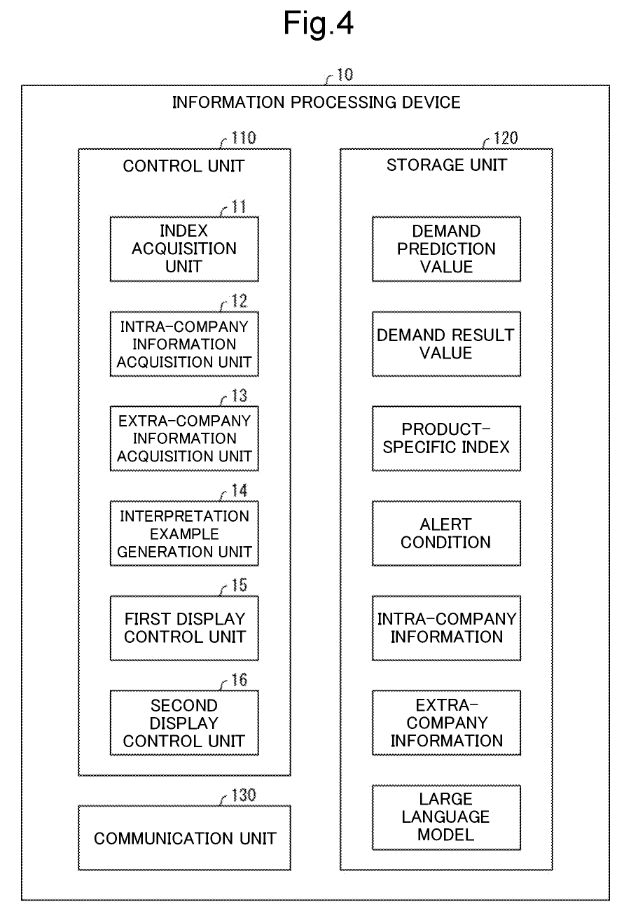

FIG. 4 is a block diagram illustrating a configuration of the information processing device 10. As illustrated in FIG. 4, the information processing device 10 includes a control unit 110, a storage unit 120, and a communication unit 130. The control unit 110 integrally controls each unit of the information processing device 10. The storage unit 120 stores various types of information referred to by the control unit 110. The communication unit 130 communicates with a device (for example, the user terminal 20) outside the information processing device 10 via the communication line NW. The communication unit 130 transmits data supplied from the control unit 110 to another device, and supplies data received from another device to the control unit 110.

### (Functional Block Included in Control Unit 110)

The control unit 110 includes a first display control unit 15 and a second display control unit 16 in addition to the index acquisition unit 11, the intra-company information acquisition unit 12, the extra-company information acquisition unit 13, and the interpretation example generation unit 14 included in the information processing system 1. The first display control unit 15 is an example of a configuration for achieving first display control means. The second display control unit 16 is an example of a configuration for achieving second display control means.

The index acquisition unit 11 is configured as follows in addition to being configured similarly to the functional block having the same name provided in the information processing system 1. The index acquisition unit 11 acquires product-specific indices for each of a plurality of products. For example, the index acquisition unit 11 may acquire the product-specific indices for each of the plurality of products included in a certain segment. Segments are categories in which a plurality of products is classified from a predetermined viewpoint, and may be, for example, brands, distribution channels, or regions where the plurality of products is sold, but are not limited to these. A detailed specific example of the index acquired by the index acquisition unit 11 in the present example embodiment will be described below.

The intra-company information acquisition unit 12 and the extra-company information acquisition unit 13 are configured similarly to the functional blocks having the same names provided in the information processing system 1. Detailed specific examples of information acquired by the intra-company information acquisition unit 12 and the extra-company information acquisition unit 13 in the present example embodiment will be described below.

The interpretation example generation unit 14 is configured as follows in addition to being configured similarly to the interpretation example generation unit 14 provided in the information processing system 1. For example, an interpretation example generated by the interpretation example generation unit 14 may include some or all of a situation of an error of demand prediction related to a certain product, a factor based on intra-company information and extra-company information related to the error of the demand prediction, and a proposal for a response to the error of the demand prediction. For example, the “situation of an error of demand prediction” may include information such as a magnitude of the error, a tendency of the error such as overforecast or underforecast, and a change in these. The “factor based on intra-company information and extra-company information related to an error of demand prediction” may include an intra-company or extra-company event that may be a factor causing the error of the demand prediction. The “proposal for a response to the error of the demand prediction” may include an example of a response that a user can take with respect to the error.

For example, the interpretation example generated by the interpretation example generation unit 14 may include an interpretation example of an index that satisfies a predetermined alert condition among product-specific indices for each of a plurality of products. The alert condition may be, for example, a condition that the product-specific index exceeds a threshold (or is equal to or more than the threshold), a condition that the product-specific index falls below the threshold (or is equal to or less than the threshold), or a combination of these, but is not limited to this.

The first display control unit 15 displays a first screen including product-specific indices for each of a plurality of products and an interpretation example of a product-specific index satisfying an alert condition on the display unit 250 of the user terminal 20 to be described below. The display unit 250 of the user terminal 20 is an example of a display device to be a display destination of the screen by the first display control unit 15.

For example, the first screen may include an index that satisfies the alert condition and a product-specific index that does not satisfy the alert condition among the product-specific indices for each of the plurality of products. The index that satisfies the alert condition and the index that does not satisfy the alert condition may be displayed in different display modes. The difference in the display mode may be, for example, a difference in a character color, a background color of a character, a font, a font size, a character decoration, or the like, but is not limited to this. The display mode that satisfies the alert condition is desirably a display mode emphasized as compared with the display mode that does not satisfy the alert condition. Displaying the product-specific index in the display mode that satisfies the alert condition is also described below as outputting an alert for the corresponding product. An interpretation example of the product-specific index for which the alert is output is also simply described as an interpretation example of the alert. Since both the alert and the interpretation example of the alert are displayed, even a user who has little knowledge related to demand prediction can recognize the product for which the alert has been output as a product for which accuracy of the demand prediction is not good and the demand prediction may need to be reviewed. It is also possible to provide support to a user having knowledge related to the demand prediction, such as reducing missing of information to be considered for recognizing a product for which the demand prediction may need to be reviewed, shortening time to collect and organize information, and increasing consideration time.

The second display control unit 16 displays, according to an operation for specifying any one of a plurality of products included in the first screen, a second screen including product-specific indices related to the specified product and an interpretation example of the product-specific indices, on the display unit 250 of the user terminal 20. For example, the interpretation example included in the second screen may include some or all of a situation of an error of demand prediction related to the product, a factor based on intra-company information and extra-company information related to the error of the demand prediction, and a proposal for a response to the error of the demand prediction, as described above. For example, in a case where the index acquisition unit 11 acquires a time series of product-specific indices in a predetermined period, the second display control unit 16 may display, on the display unit 250, the second screen including a graph obtained by plotting the time series of the product-specific indices related to the specified product and an interpretation example. For example, by referring to the interpretation example on an alert screen and specifying a product for which an alert is output, a user can confirm product-specific indices related to the product on the second screen related to the product. Since both the product-specific indices and the interpretation example of the product-specific indices are displayed, it is possible to support a user who has little knowledge related to the demand prediction to analyze an error of the demand prediction related to the corresponding product. It is also possible to provide support to a user having knowledge related to the demand prediction, such as reducing missing of information to be considered for analyzing the error of the demand prediction related to the corresponding product, shortening time to collect and organize information, and increasing consideration time.

### (Information Stored in Storage Unit 120)

The storage unit 120 stores various types of information to be referred to by the control unit 110. Examples of such information include a demand prediction value, a demand result value, an index, an alert condition, intra-company information, extra-company information, and a large language model. Some or all of these pieces of information may be stored in an external device different from the information processing device 10.

### (Demand Prediction Value)

The demand prediction value indicates a result of demand prediction related to a product handled by an object company. For example, the demand prediction value is a value representing demand predicted in a future unit period, and may be a predicted sales amount, a predicted sales quantity, or the like. In a case where it is assumed that the unit period is, for example, one week, the storage unit 120 may store, for example, identification information of the product, a future period (for example, the second week of April, 2024), and a demand prediction value (for example, the predicted sales quantity of 120) in the period in association with each other. The unit period is not limited to one week, and may be one day, one month, one quarter, one year, or the like, but is not limited to these. The demand prediction value may be additionally stored in the storage unit 120 each time demand prediction is performed for a new future period.

### (Demand Result Value)

The demand result value indicates a past result of demand related to a product handled by an object company. For example, the demand result value is a value representing demand in a past unit period, and may be, as an example, a result value of a sales amount, a result value of a sales quantity, or the like. In a case where it is assumed that the unit period is, for example, one week, the storage unit 120 may store, for example, identification information of the product, a past period (for example, the first week of April, 2024), and a demand result value (for example, the result value of the sales quantity of 100) in the period in association with each other. The unit period is not limited to one week, and may be, for example, one day, one month, one quarter, or one year, but is not limited to these. The demand result value may be additionally stored in the storage unit 120 each time a demand result value is obtained for a new past period.

### (Product-Specific Index)

The product-specific index is an index for managing accuracy of demand prediction related to a product handled by an object company. Examples of the product-specific index include some or all of a mean absolute percentage error (MAPE) impact, a tracking signal, channel information, a landing deviation rate, a past error rate, and a demand result past ratio. However, the index is not limited to these.

### (MAPE Impact)

An MAPE impact is an index obtained by weighting an error rate of demand prediction of a corresponding product according to importance of the product. For example, the MAPE impact is calculated by the following Expression (1).

MAPE impact = [absolute value of error rate of demand prediction of product] × [weight of product]... (1) Here, the “error rate of demand prediction” is calculated by the following Expression (2).

Error rate of demand prediction = [difference between demand prediction value and demand result value]/[demand result value]... (2) Here, “/” indicates division. For example, the “weight of product” may be determined to be larger as a sales scale of the product is larger. In this case, the larger the sales scale and the larger an error of the demand prediction of the product, the larger a value of the MAPE impact. In other words, the product having the high MAPE impact is the product having the large error of the demand prediction and the large sales scale. With the MAPE impact, it is possible to grasp the product for which the demand prediction needs to be reviewed preferentially.

### (Tracking Signal)

The tracking signal is an index indicating a degree to which an error of demand prediction of a corresponding product continues to be biased in the same direction. Here, the error of the demand prediction is biased in a positive direction in a case where a demand prediction value is higher than a demand result value, and is biased in a negative direction in a case where the demand prediction value is lower than the demand result value. The “error... continues to be biased in the same direction” refers to that the error continues to be biased in any one of the positive direction and the negative direction. For example, the tracking signal is calculated by the following Expression (3).

Tracking signal = [f-Bias of product]/[MAD]... (3) Here, the MAD indicates a mean absolute deviation of the error of the product. The f-Bias indicates a cumulative error of the demand prediction related to the corresponding product, and is calculated by, for example, the following Expression (4).

f-Bias = sum total of ([demand prediction value] - [demand result value])... (4) Here, the sum total is a sum total in a predetermined unit period.

In a case where the tracking signal has a positive value, the larger an absolute value is, the longer a period during which the error of the demand prediction continues to be biased in the positive direction is, indicating that an excess inventory risk of the corresponding product increases. In a case where the tracking signal has a negative value, the larger the absolute value is, the longer a period during which the error of the demand prediction continues to be biased in the negative direction is, indicating that a stock-out risk of the corresponding product increases. By confirming the tracking signal, for example, a person in charge of managing the corresponding product can promptly modify the demand prediction for each product.

### (Channel Information)

The channel information is information related to a channel of a corresponding product. The channel is a distribution route of the product, and specific examples of the channel include a drug store and a department store, but are not limited to these. The channel of the corresponding product may affect accuracy of demand prediction. Therefore, the channel information can be an index for managing the accuracy of the demand prediction. The channel information may include, for example, a channel configuration ratio constituting a demand result (for example, a shipping result) of the corresponding product. The channel information may also include, for example, a channel-specific year-on-year comparison of the demand result of the corresponding product. However, the channel information is not limited to these.

### (Landing Deviation Rate)

The landing deviation rate indicates a degree of deviation of a landing prediction value from a demand prediction value. The landing prediction value indicates, for example, a result of predicting, based on a demand result value up to a middle point of a current unit period (for example, this week), demand for the entire unit period up to an end point of the unit period (for example, this weekend). On the other hand, the demand prediction value indicates a result of predicting demand for the unit period before the current unit period starts (alternatively, without referring to the demand result value up to the middle point of the current unit period).

### (Past Error Rate)

The past error rate indicates an error rate of demand prediction in the past. As described above, the error rate of the demand prediction is calculated by, for example, the above Expression (2). In a case where it is assumed that a unit period for calculating the past error rate is a week unit, an example of the past error rate may be an error rate of the demand prediction in a previous week (hereinafter, also described as a previous week error rate).

### (Demand Result Past Ratio)

The demand result past ratio is a ratio of the latest demand result value to a past demand result value. The latest demand result value may be, for example, a moving average of demand result values in the latest predetermined period.

The demand result past ratio may be calculated for each type of distribution destination through which a shipped product passes on a distribution route. For example, in a case where an object company is a manufacturer, the type of distribution destination may be an intermediary, a retailer, or the like through which the shipped product passes. For example, assuming that an object to be compared is one year ago, an example of the demand result past ratio may include one or both of a wholesale shipping moving average in a year-on-year comparison and a point of sale (POS) moving average in a year-on-year comparison. The wholesale shipping moving average in a year-on-year comparison is a moving average of shipping result values in a year-on-year comparison from an intermediary to a retailer. The POS moving average in a year-on-year comparison is a moving average of sales result values in a year-on-year comparison from a retailer to a consumer. However, the demand result past ratio is not limited to the above-described example.

### (Alert Condition)

The alert condition is a condition related to a product-specific index, and is set to output an alert for a product for which demand prediction may need to be reviewed. For example, the alert condition may be set for each type of a plurality of product-specific indices. For example, the alert condition may be that a corresponding product-specific index (or an absolute value of the product-specific index) exceeds (or falls below) a threshold. A specific example of the alert output by satisfying each type of alert condition will be described below.

### (Intra-Company Information)

As described above, the intra-company information is information obtained in an object company, and may be information specific to the object company. For example, the intra-company information may include one or both of promotion information in the object company related to a product and sales information of another product in the object company in the same category as the product. The intra-company information may also include some or all of product information, a demand prediction value, a demand result value, and a distribution result value related to the product.

The information indicating a promotion may be, for example, information including an activity for promoting sales of the product, a period during which the activity is performed, and the like. The product information may include a price, an attribute, and the like of the product. The demand prediction value or the demand result value of the product may be information for each of retail sales, wholesale shipping, and manufacturer shipping. The distribution result value of the product may be the number of distribution destinations (for example, the number of stores) to which the product is distributed. However, the intra-company information is not limited to the above-described example. The intra-company information may be stored for each of a plurality of products.

The intra-company information may be updated to the latest information at predetermined timings, or the latest information may be added. The intra-company information may be information in which items and values indicating the above-described various types of information are associated, or may be a document (for example, a journal or the like in the object company) including a natural language sentence that can include the above-described various types of information.

### (Extra-Company Information)

As described above, the extra-company information is information obtained from outside an object company, and may be general-purpose information independent of the object company. For example, the extra-company information may include some or all of release of a new product of a competing brand of a product, trend information of the competing brand, and trend information of a market to which the product belongs. The extra-company information may also include some or all of a change in regulations related to an industry related to the product and information indicating an external environment of the industry. For example, the change in the regulations related to the industry may be price revision. For example, the information indicating the external environment of the industry may be an external variable such as weather information, an exchange rate, or the number of foreign visitors to Japan. However, the extra-company information is not limited to the above-described example.

The extra-company information may be updated to the latest information at predetermined timings, or the latest information may be added. The extra-company information may be information in which items and values indicating the above-described various types of information are associated, or may be a document (for example, a journal of the industry or a journal related to the external environment) including a natural language sentence that can include the above-described various types of information.

### (Large language model)

The large language model is a deep learning model generated to execute a natural language processing task. For example, the large language model may be a trained general-purpose large language model, or may be a model obtained by fine-tuning such a general-purpose large language model. For example, the large language model may be a model that executes a sentence generation task, and that outputs a generated natural language sentence with a prompt by the natural language sentence as an input.

### (Configuration of User Terminal 20)

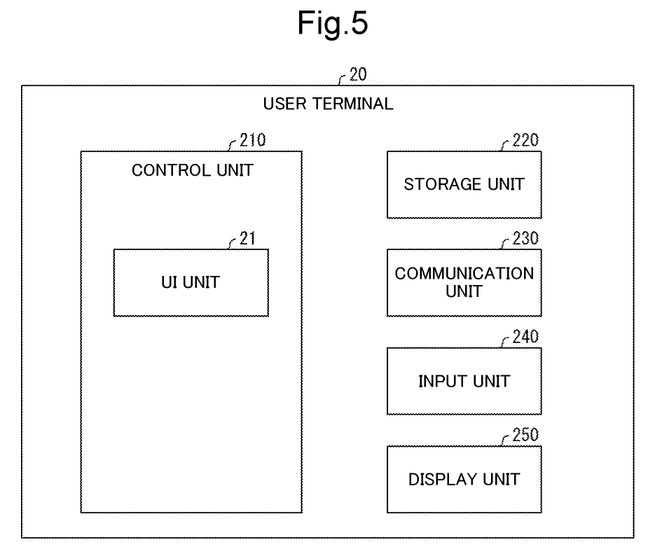

FIG. 5 is a block diagram illustrating a configuration of the user terminal 20. As illustrated in FIG. 5, the user terminal 20 includes a control unit 210, a storage unit 220, a communication unit 230, an input unit 240, and the display unit 250. The control unit 210 integrally controls each unit of the user terminal 20. The storage unit 220 stores various types of information referred to by the control unit 210. The communication unit 230 communicates with a device (for example, the information processing device 10) outside the user terminal 20 via the communication line NW. The communication unit 230 transmits data supplied from the control unit 210 to another device, and supplies data received from another device to the control unit 210.

The input unit 240 is a configuration for receiving an input to the user terminal 20, and may include, as an example, an input device such as a keyboard, a mouse, a touch panel, a camera, and a microphone. The display unit 250 is a configuration for displaying a screen output from the user terminal 20, and may include, as an example, a display. The input unit 240 and the display unit 250 may be integrally formed as a touch panel or the like. One or both of the input unit 240 and the display unit 250 are not limited to being built in the user terminal 20, and may be connected to the outside via an interface such as a universal serial bus (USB), for example.

The control unit 210 includes a user interface (UI) unit 21. The UI unit 21 provides a user interface for using a service for analyzing an error of demand prediction. For example, the UI unit 21 receives an operation of a user for using the service and transmits the operation to the information processing device 10. In a case where the user terminal 20 receives a screen related to the service from the information processing device 10, the UI unit 21 displays the received screen on the display unit 250. For example, the UI unit 21 may be achieved by executing an application program for using the service, which is stored in the storage unit 220. The application program may be an application dedicated to the service. In a case where the service is achieved as a web service, the application program may be a general-purpose web browser.

### (Flow of Information Processing Method S1A)

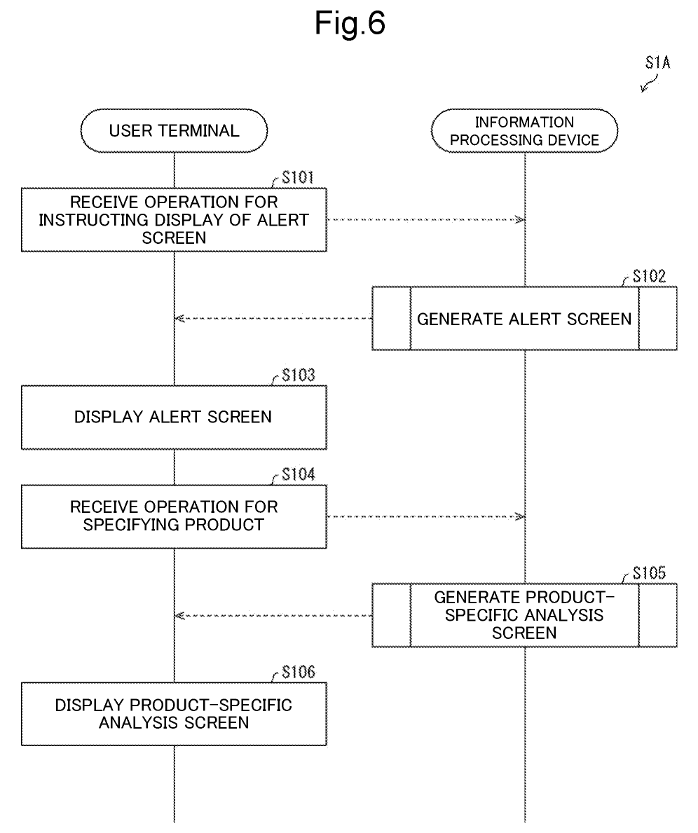

The information processing system 1A configured as described above executes an information processing method S1A. FIG. 6 is a flowchart illustrating a flow of the information processing method S1A. As illustrated in FIG. 6, the information processing method S1A includes steps S101 to S106. In the following description, an example of the first screen will be described as an “alert screen”, and an example of the second screen will be described as a “product-specific analysis screen”. However, names of the first screen and the second screen are not limited to these.

In step S101, the UI unit 21 of the user terminal 20 receives an operation for instructing display of the alert screen. For example, the operation of a user may be an operation on a menu item “display alert screen” on a menu screen (not illustrated) displayed on the display unit 250, but is not limited to this. The operation of the user may further include an operation for specifying a plurality of products to be objects on the alert screen. The plurality of products may be specified as a predetermined segment, for example. Segments are categories in which a plurality of products is classified from a predetermined viewpoint, and may be, for example, brands, distribution channels, or regions where the plurality of products is sold, but are not limited to these. The operation of the user may further include an operation for specifying a past predetermined period (for example, a predetermined year, a predetermined month, and a start date and an end date of the period) to be the object on the alert screen. The UI unit 21 transmits, to the information processing device 10, information (for example, information instructing display of the alert screen, information indicating the plurality of products included in the alert screen, and information indicating the predetermined period) indicated by the received operation.

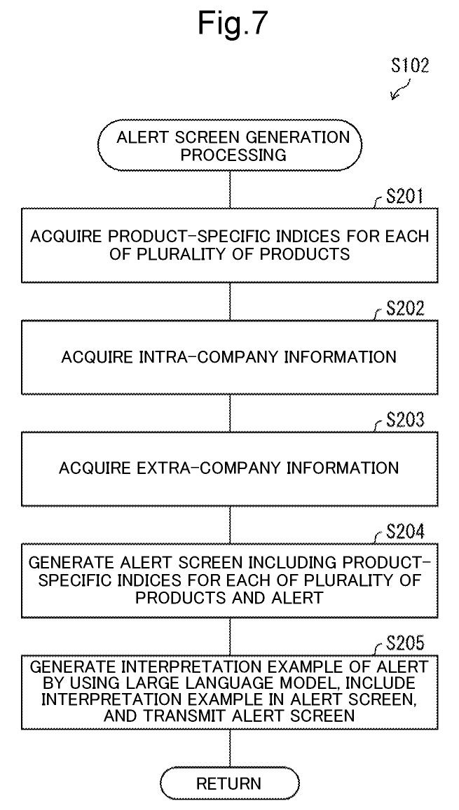

In step S102, the control unit 110 of the information processing device 10 generates the alert screen and transmits the generated alert screen to the user terminal 20. FIG. 7 is a flowchart illustrating a detailed flow of the alert screen generation processing in step S102. As illustrated in FIG. 7, the alert screen generation processing includes steps S201 to S205.

In step S201, the index acquisition unit 11 acquires a landing deviation rate, a past error rate, a tracking signal, and a demand result past ratio as product-specific indices for each of the plurality of products to be included in the alert screen. For example, the index acquisition unit 11 may acquire the product-specific indices related to each product by reading the product-specific indices from the storage unit 120. The index acquisition unit 11 may acquire the product-specific indices by calculating, for each product, the product-specific indices based on a demand prediction value and a demand result value stored in the storage unit 120. In a case where the operation for specifying the plurality of products to be included in the alert screen is not received in step S101, a plurality of products determined in advance or all products handled by an object company may be applied. In a case where the operation for specifying the predetermined period is not received in step S101, a predetermined period determined in advance may be applied.

In step S202, the intra-company information acquisition unit 12 acquires intra-company information. For example, the intra-company information acquisition unit 12 may acquire the intra-company information related to the predetermined period by reading the intra-company information from the storage unit 120.

In step S203, the extra-company information acquisition unit 13 acquires extra-company information. For example, the extra-company information acquisition unit 13 may acquire the extra-company information related to the predetermined period by reading the extra-company information from the storage unit 120.

Steps S201 to S203 are not necessarily executed in this order, and may be executed in a different order or partially or entirely in parallel.

In step S204, the first display control unit 15 specifies an index that satisfies an alert condition among the product-specific indices for each of the plurality of products. In other words, the first display control unit 15 specifies a product for which an alert is to be output. The first display control unit 15 generates the alert screen including the product-specific indices for each of the plurality of products and the alert.

In step S205, the interpretation example generation unit 14 generates, with reference to the product-specific indices for each of the plurality of products, the intra-company information, and the extra-company information, sentences as an interpretation example of the alert by using a large language model. The interpretation example generation unit 14 includes the interpretation example in the alert screen and transmits the alert screen to the user terminal 20.

For example, the interpretation example generation unit 14 may generate a prompt including the index that satisfies the alert condition among the product-specific indices for each of the plurality of products, the intra-company information, the extra-company information, and cases. The interpretation example generation unit 14 may also acquire, as the interpretation example, sentences output from the large language model by inputting the prompt to the large language model. Examples of the cases included in the prompt include a case of the index that satisfies the alert condition among the product-specific indices for each of the plurality of optional products, a case of the intra-company information, a case of the extra-company information, and a case of the sentences as the interpretation example of the alert. Examples of the cases of the sentences as the interpretation example may include a case of a situation of the alert, a case of a product to be noted based on the alert, and a case of a proposal for a response to the alert based on the intra-company information or the extra-company information.

In step S103 of FIG. 6, the UI unit 21 of the user terminal 20 displays the received alert screen on the display unit 250.

### (Screen Example)

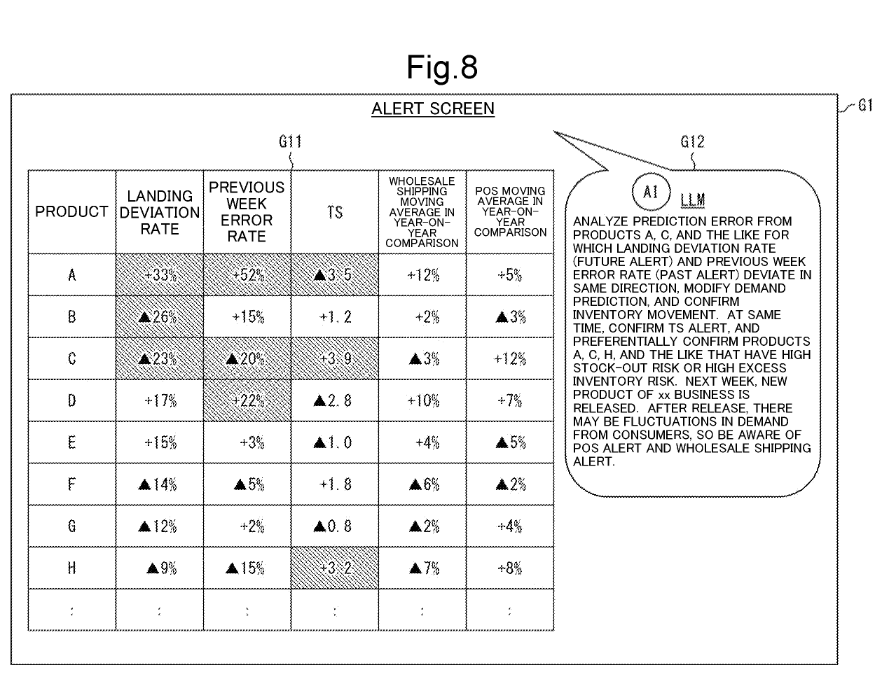

FIG. 8 is a diagram illustrating an example of the alert screen displayed on the display unit 250 in step S103. As illustrated in FIG. 8, a screen example G1 is an example of the alert screen related to the plurality of products. The screen example G1 includes regions G11 and G12.

The region G11 is a list of the plurality of types of product-specific indices related to the plurality of products. In the region G11, the plurality of types of product-specific indices includes a landing deviation rate, a previous week error rate, a tracking signal (TS), a wholesale shipping moving average in a year-on-year comparison, and a POS moving average in a year-on-year comparison. The region G11 also includes alerts. Specifically, in the region G11, a cell of an index that does not satisfy the alert condition is displayed in a white display mode. A cell of an index that satisfies the alert condition is displayed in a display mode filled with a hatched pattern, and is emphasized as compared with the cell of the index that does not satisfy the alert condition. That is, the cell filled with the hatched pattern indicates the alert output for the corresponding product.

The alerts included in the screen example G1 are referred to as a future alert, a past alert, a TS alert, a wholesale shipping change alert, and a POS change alert, as an example, for each type of the related product-specific indices. Hereinafter, each type of the alerts will be described.

### (Future Alert)

The future alert is an alert that is output in a case where an absolute value of the landing deviation rate as an example of the product-specific indices is equal to or more than a threshold. That is, the future alert is output in a case where there is a large possibility that a demand prediction value calculated for a current unit period and the landing prediction value calculated with reference to a demand result up to a middle point of the unit period deviate from each other. Therefore, the future alert indicates a product for which an error of demand prediction in the unit period may become large at a future time point (for example, this weekend) in a case where the current unit period (for example, this week) ends.

In the screen example G1, for example, it is assumed that “the absolute value of the landing deviation rate is equal to or more than 20%” is set as the alert condition for outputting the future alert. However, the threshold of 20% is an example, and the threshold is not limited to this. As a result, cells of landing deviation rates of products A, B, and C satisfying the alert condition are filled with the hatched pattern. That is, the future alert is output for the products A, B, and C.

Since the list illustrated in the region G11 is sorted in descending order of the landing deviation rate, the future alert is output for the three cells in order from the top related to the products having exceeded the threshold in the list.

### (Past Alert)

The past alert is an alert that is output in a case where an absolute value of the previous week error rate as an example of the product-specific indices is equal to or more than a threshold. That is, the past alert is output in a case where a demand prediction value calculated for a past unit period and a demand result value for the unit period deviate from each other. Therefore, the past alert indicates a product for which an error of demand prediction is large in the past unit period (for example, a previous week).

In the screen example G1, for example, it is assumed that “the absolute value of the previous week error rate is equal to or more than 20%” is set as the alert condition for outputting the past alert. However, the threshold of 20% is an example, and the threshold is not limited to this. As a result, cells of previous week error rates of products A, C, and D satisfying the alert condition are filled with the hatched pattern. That is, the past alert is output for the products A, C, and D.

As described above, the list illustrated in the region G11 is sorted in descending order of the landing deviation rate. In a case where the plurality of products as the objects of the alert screen illustrated in the screen example G1 includes products in addition to the products A to H, for example, there is a possibility that the past alert is also output for the other products that are not displayed. For example, the user may be able to perform an operation for sorting the list illustrated in the region G11 in descending order of the previous week error rate (for example, an operation for clicking/tapping a cell including characters of “previous week error rate”). By performing the operation, the user can recognize the products for which the past alert has been output in descending order of the previous week error rate.

### (TS Alert)

The TS alert is an alert that is output in a case where an absolute value of the tracking signal as an example of the product-specific indices is equal to or more than a threshold. That is, the TS alert indicates a product for which an error of demand prediction continues to be biased in a specific direction.

In the screen example G1, for example, it is assumed that “the absolute value of the tracking signal is equal to or more than 3.2” is set as the alert condition for outputting the TS alert. However, the threshold of 3.2 is an example, and the threshold is not limited to this. As a result, cells of tracking signals for the products A, C, and H satisfying the alert condition are filled with the hatched pattern. That is, the TS alert is output for the products A, C, and H.

As described above, the list illustrated in the region G11 is sorted in descending order of the landing deviation rate. In a case where the plurality of products as the objects of the alert screen illustrated in the screen example G1 includes products in addition to the products A to H, for example, there is a possibility that the TS alert is also output for the other products that are not displayed. For example, the user may be able to perform an operation for sorting the list illustrated in the region G11 in descending order of the tracking signal (for example, an operation for clicking/tapping a cell including characters of “TS”). By performing the operation, the user can recognize the products for which the TS alert has been output in descending order of the tracking signal.

### (Wholesale Shipping Change Alert)

The wholesale shipping change alert is an alert that is output in a case where an absolute value of the wholesale shipping moving average in a year-on-year comparison as an example of the product-specific indices is equal to or more than a threshold. That is, the wholesale shipping change alert indicates a product for which a result value of wholesale shipping deviates in a year-on-year comparison. For a product for which there is no record of the result value of the wholesale shipping in the previous year to be compared, a change rate of a moving average of wholesale shipping result values may be applied instead of the wholesale shipping moving average in a year-on-year comparison.

In the screen example G1, for example, it is assumed that “the absolute value of the wholesale shipping moving average in a year-on-year comparison is equal to or more than 15%” is set as the alert condition for outputting the wholesale shipping change alert. However, the threshold of 15% is an example, and the threshold is not limited to this. Since none of the products A to H satisfy the alert condition, none of cells of the wholesale shipping moving average in a year-on-year comparison are filled with the hatched pattern. That is, the wholesale shipping change alert is not output in the region G11.

As described above, the list illustrated in the region G11 is sorted in descending order of the landing deviation rate. In a case where the plurality of products as the objects of the alert screen illustrated in the screen example G1 includes products in addition to the products A to H, for example, there is a possibility that the wholesale shipping change alert is output for the other products that are not displayed. For example, the user may be able to perform an operation for sorting the list illustrated in the region G11 in descending order of the wholesale shipping moving average in a year-on-year comparison (for example, an operation for clicking/tapping a cell including characters of “wholesale shipping moving average in a year-on-year comparison”). By performing the operation, the user can recognize the products for which the wholesale shipping change alert has been output in descending order of the wholesale shipping moving average in a year-on-year comparison.

### (POS Change Alert)

The POS change alert is an alert that is output in a case where an absolute value of the POS moving average in a year-on-year comparison as an example of the product-specific indices is equal to or more than a threshold. That is, the POS change alert indicates a product for which a result value of a POS deviates in a year-on-year comparison. For a product for which there is no record of a sales result value from a retailer to a consumer in the previous year to be compared, a change rate of a moving average of the sales result values may be applied instead of the POS moving average in a year-on-year comparison.

In the screen example G1, for example, it is assumed that “the absolute value of the POS moving average in a year-on-year comparison is equal to or more than 15%” is set as the alert condition for outputting the POS change alert. However, the threshold of 15% is an example, and the threshold is not limited to this. Since none of the products A to H satisfy the alert condition, none of cells of the POS moving average in a year-on-year comparison are filled with the hatched pattern. That is, the POS change alert is not output in the region G11.

As described above, the list illustrated in the region G11 is sorted in descending order of the landing deviation rate. In a case where the plurality of products as the objects of the alert screen illustrated in the screen example G1 includes products in addition to the products A to H, for example, there is a possibility that the POS change alert is output for the other products that are not displayed. For example, the user may be able to perform an operation for sorting the list illustrated in the region G11 in descending order of the POS moving average in a year-on-year comparison (for example, an operation for clicking/tapping a cell including characters of “POS moving average in a year-on-year comparison”). By performing the operation, the user can recognize the products for which the POS change alert has been output in descending order of the POS moving average in a year-on-year comparison.

### (Interpretation Example)

The region G12 includes sentences as an interpretation example of each type of the above-described alerts. Among the sentences as the interpretation example, a sentence “Analyze a prediction error (in other words, an error of demand prediction) from the products A, C, and the like for which the landing deviation rate (future alert) and the previous week error rate (past alert) deviate in the same direction, modify the demand prediction, and confirm inventory movement” indicates interpretation of the future alert and the past alert and a proposal. A sentence “At the same time, confirm the TS alert, and preferentially confirm the products A, C, H, and the like that have a high stock-out risk or a high excess inventory risk” indicates interpretation of the TS alert and a proposal. Sentences “Next week, a new product of XX business is released. After release, there may be fluctuations in demand from consumers, so be aware of the POS alert and the wholesale shipping alert” indicate a proposal related to the POS alert and the wholesale shipping alert based on the intra-company information.

In this manner, according to the alert screen illustrated in the screen example G1, the user can recognize the product with high priority for which the demand prediction needs to be modified by combining the plurality of types of alerts. According to the alert screen, since the interpretation examples related to the plurality of types of alerts are displayed together with the plurality of types of alerts, even a user who has little knowledge related to the demand prediction can easily recognize the product with high priority for which the demand prediction needs to be modified. With the screen example G1, it is possible to provide support to a user having knowledge related to the demand prediction, such as reducing missing of information to be considered for recognizing the product with high priority for which the demand prediction needs to be modified, shortening time to collect and organize information, and increasing consideration time.

In step S104 of FIG. 6, the UI unit 21 of the user terminal 20 receives an operation of the user for specifying any one of the plurality of products included in the alert screen. The operation of the user is performed to specify the product to be an object on the product-specific analysis screen. For example, in the screen example G1 illustrated in FIG. 8, the user may perform an operation for specifying the product A or C with reference to “ the products A, C, and the like for which the landing deviation rate (future alert) and the previous week error rate (past alert) deviate in the same direction” included in the interpretation example of the region G12. The operation for specifying the product may be, for example, an operation for clicking/tapping a cell including characters such as the product A or C, but is not limited to this.

The operation of the user may further include an operation for specifying a past predetermined period (for example, a predetermined year, a predetermined month, and a start date and an end date of the period) to be the object on the product-specific analysis screen. The UI unit 21 transmits, to the information processing device 10, information (for example, information instructing display of the product-specific analysis screen, information indicating the specified product, and information indicating the predetermined period) indicated by the received operation.

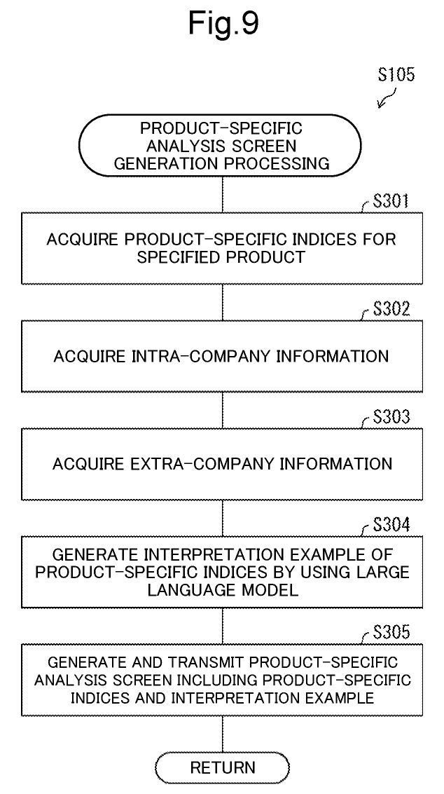

In step S105, the control unit 110 of the information processing device 10 generates the product-specific analysis screen and transmits the generated product-specific analysis screen to the user terminal 20. FIG. 9 is a flowchart illustrating a detailed flow of the product-specific analysis screen generation processing in step S105. As illustrated in FIG. 9, the product-specific analysis screen generation processing includes steps S301 to S305.

In step S301, the index acquisition unit 11 acquires the landing deviation rate, the past error rate, the tracking signal, and the demand result past ratio as the product-specific indices for the specified product. For example, the index acquisition unit 11 may acquire, for the corresponding product, a time series of the indices in the predetermined period by reading the time series of the indices from the storage unit 120. The index acquisition unit 11 may acquire, for the corresponding product, the time series of the indices in the predetermined period by calculating the time series of the indices based on the demand prediction value and the demand result value stored in the storage unit 120. In a case where the operation for specifying the predetermined period is not received in step S104, a predetermined period determined in advance may be applied.

In step S302, the intra-company information acquisition unit 12 acquires intra-company information. For example, the intra-company information acquisition unit 12 may acquire the intra-company information related to the predetermined period by reading the intra-company information from the storage unit 120.

In step S303, the extra-company information acquisition unit 13 acquires extra-company information. For example, the extra-company information acquisition unit 13 may acquire the extra-company information related to the predetermined period by reading the extra-company information from the storage unit 120.

Steps S301 to S303 are not necessarily executed in this order, and may be executed in a different order or partially or entirely in parallel.

In step S304, the second display control unit 16 generates, with reference to the time series of the product-specific indices related to the product, the intra-company information, and the extra-company information, sentences as an interpretation example by using a large language model. Examples of the interpretation example include a situation of an error of demand prediction for the product, a factor based on the intra-company information and the extra-company information related to the error of the demand prediction, and a proposal for a response to the error of the demand prediction.

For example, the interpretation example generation unit 14 may generate a prompt including the time series of the product-specific indices related to the specified product, the intra-company information, the extra-company information, and cases, and input the prompt to the large language model. The interpretation example generation unit 14 may also acquire, as the interpretation example, sentences output from the large language model by inputting the prompt to the large language model. Examples of the cases included in the prompt include a case of the time series of the product-specific indices for the optional product, a case of the intra-company information, a case of the extra-company information, and a case of the sentences as the interpretation example. Examples of the sentences as the interpretation example include a case of the situation of the error of the demand prediction for the optional product, a case of the factor related to the demand prediction, and a case of the proposal for the response to the error of the demand prediction.

In step S305, the second display control unit 16 generates the product-specific analysis screen including the time series of the product-specific indices for the specified product and the interpretation example. The second display control unit 16 transmits the product-specific analysis screen to the user terminal 20.

In step S106 of FIG. 6, the UI unit 21 of the user terminal 20 displays the received product-specific analysis screen on the display unit 250.

### (Screen Example)

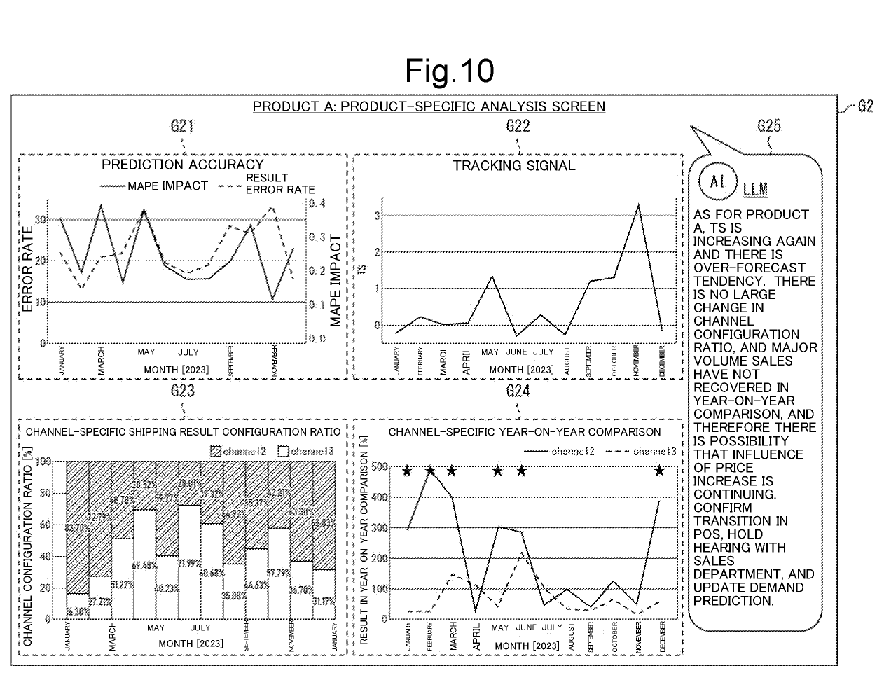

FIG. 10 is a diagram illustrating an example of the product-specific analysis screen displayed on the display unit 250 in step S106. Here, it is assumed that an operation for specifying the product A is performed on the alert screen illustrated in FIG. 8. As illustrated in FIG. 10, a screen example G2 is an example of the product-specific analysis screen related to the specified product A. The screen example G2 includes regions G21 to G25. The region G21 includes a graph indicating a transition of a MAPE impact in a predetermined period related to the product A. The region G22 includes a graph indicating a transition of a tracking signal in a predetermined period related to the product A. The region G23 includes a graph indicating a transition of a channel configuration ratio of a shipping result in a predetermined period related to the product A. The region G24 includes a graph indicating a transition of a channel-specific year-on-year comparison of a shipping result in a predetermined period related to the product A.

The region G25 includes sentences as an interpretation example. Among the sentences as the interpretation example, a sentence “As for the product A, the TS is increasing again and there is an Over-forecast tendency” indicates a situation of a prediction error related to the product A. A sentence “There is no large change in the channel configuration ratio” indicates a channel-specific situation for analyzing the prediction error related to the product A. With such sentences indicating the situations, even a user with little knowledge related to demand prediction can easily grasp the situations of the prediction error and channel information indicated by the graphs illustrated in the regions G21 to G24. Among the sentences as the interpretation example, a sentence “major volume sales have not recovered in a year-on-year comparison, and therefore there is a possibility that the influence of the price increase is continuing” indicates a factor of the prediction error. With such a sentence indicating the factor of the prediction error, even a user with little knowledge related to the demand prediction can easily grasp the factor of an error of the demand prediction in consideration of intra-company information and extra-company information. Among the sentences as the interpretation example, a sentence “Confirm a transition in the POS, hold a hearing with the sales department, and update the demand prediction” indicates a proposal for a response to the error of the demand prediction. With such a sentence indicating the proposal, even a user with little knowledge related to the demand prediction can easily respond to the error of the demand prediction related to the corresponding product. With the screen example G2, it is possible to provide support to a user having knowledge related to the demand prediction, such as reducing missing of information to be considered for analyzing the error of the demand prediction related to the corresponding product, shortening time to collect and organize information, and increasing consideration time.

### (First Modification)

The interpretation example generation unit 14 may generate the interpretation example on the alert screen and/or the interpretation example on the product-specific analysis screen as follows by using a knowledge base in addition to the large language model. In the present modification, the intra-company information and the extra-company information acquired by the intra-company information acquisition unit 12 and the extra-company information acquisition unit 13 are added to a knowledge base (not illustrated). As a result, the knowledge base is updated to the latest state. The knowledge base may be stored in the storage unit 120 or may be stored in an external device different from the information processing device 10.

For example, in order to generate the interpretation example on the alert screen, the interpretation example generation unit 14 may search for information related to an index that satisfies the alert condition among the product-specific indices for each of the plurality of products from the knowledge base updated to the latest state. The interpretation example generation unit 14 may input a prompt including the search result and the time series of the indices to the large language model. As a result, sentences as the interpretation example of the alert are output from the large language model.

For example, in order to generate the interpretation example on the product-specific analysis screen, the interpretation example generation unit 14 may search for information related to the time series of the product-specific indices related to the specified product from the knowledge base updated to the latest state. The interpretation example generation unit 14 may input a prompt including the search result and the time series of the indices to the large language model. As a result, sentences as the interpretation example of the product-specific indices related to the product are output from the large language model.

For example, in the present modification, in step S202 or S203 or step S302 or S303, processing of adding the acquired intra-company information and extra-company information to the knowledge base may be further performed. Steps S202 and S203 do not need to be performed after the reception of the operation for instructing display of the alert screen (S101), and may be executed at an optional time point (for example, periodically). Steps S302 and S303 do not need to be performed after the reception of the operation for specifying the product for which the product-specific analysis screen is to be displayed (S104), and may be executed at an optional time point (for example, periodically).

### (Second Modification)

The interpretation example generation unit 14 may generate the interpretation example on the alert screen and/or the interpretation example on the product-specific analysis screen as follows by additionally training the large language model. In the present modification, the large language model is additionally trained by using the intra-company information and the extra-company information acquired by the intra-company information acquisition unit 12 and the extra-company information acquisition unit 13. As a result, the large language model is updated to the latest state.

For example, in order to generate the interpretation example on the alert screen, the interpretation example generation unit 14 may input an index that satisfies the alert condition among the product-specific indices for each of the plurality of products to the large language model updated to the latest state. As a result, sentences as the interpretation example of the alert are output from the large language model.

For example, in order to generate the interpretation example on the product-specific analysis screen, the interpretation example generation unit 14 may input the time series of the product-specific indices related to the specified product to the large language model updated to the latest state. As a result, sentences as the interpretation example of the product-specific indices related to the product are output from the large language model.

For example, in the present modification, in step S202 or S203 or step S302 or S303, processing of additionally training the large language model by using the acquired intra-company information and extra-company information may be further performed. Steps S202 and S203 do not need to be performed after the reception of the operation for instructing display of the alert screen (S101), and may be executed at an optional time point (for example, periodically). Steps S302 and S303 do not need to be performed after the reception of the operation for specifying the product for which the product-specific analysis screen is to be displayed (S104), and may be executed at an optional time point (for example, periodically).

### (Third Modification)

The product-specific analysis screen is not necessarily displayed transitioning from the alert screen.

For example, the product-specific analysis screen may be displayed according to an optional operation for specifying a product, or may be displayed for an object product set in advance.

### (Effects of Information Processing System 1A)

As described above, the information processing system 1A adopts the configuration in which an interpretation example includes some or all of a situation of an error of demand prediction related to a product, a factor based on intra-company information and extra-company information related to the error of the demand prediction, and a proposal for a response to the error of the demand prediction. Therefore, according to the information processing system 1A, in addition to the effects provided by the information processing system 1, it is possible to obtain effects that it is possible to easily grasp the situation and the factor of the error of the demand prediction and easily respond to the error of the demand prediction.

The information processing system 1A also adopts the configuration in which the index acquisition unit 11 acquires product-specific indices for each of a plurality of products, and the interpretation example includes an interpretation example of an index that satisfies a predetermined alert condition among the product-specific indices for each of the plurality of products. Therefore, according to the information processing system 1A, in addition to the effects provided by the information processing system 1, it is possible to obtain an effect that a situation of a product related to the product-specific index that satisfies the alert condition (in other words, the product for which an alert has been output) can be easily grasped.

The information processing system 1A also adopts the configuration further including the first display control unit 15 that displays, on a display device, a first screen including the product-specific indices for each of the plurality of products and the interpretation example of the product-specific index that satisfies the alert condition, and the second display control unit 16 that displays, according to an operation for specifying any one of the plurality of products included in the first screen, a second screen including the product-specific indices related to the specified product and an interpretation example of the product-specific indices, on the display device. Therefore, according to the information processing system 1A, in addition to the effects provided by the information processing system 1, it is possible to obtain an effect that an error of demand prediction indicated by the product-specific indices can be easily analyzed for the product specified with reference to the interpretation example included in the alert screen.

The information processing system 1A also adopts the configuration in which the intra-company information includes one or both of promotion information in an object company related to the product and sales information of another product in the object company in the same category as the product. Therefore, according to the information processing system 1A, in addition to the effects provided by the information processing system 1, it is possible to obtain an effect that it is possible to present, to a user, the interpretation example in consideration of one or both of the promotion information in the object company related to the product and the sales information of the another product in the object company in the same category as the product, for the error of the demand prediction indicated by the product-specific indices.

The information processing system 1A also adopts the configuration in which the extra-company information includes some or all of release of a new product of a competing brand of the product, trend information of the competing brand, and trend information of a market to which the product belongs. Therefore, according to the information processing system 1A, in addition to the effects provided by the information processing system 1, it is possible to obtain an effect that it is possible to present, to the user, the interpretation example in consideration of some or all of release of the new product of the competing brand of the product, the trend information of the competing brand, and the trend information of the market to which the product belongs, for the error of the demand prediction indicated by the product-specific indices.

The information processing system 1A also adopts the configuration in which the intra-company information includes some or all of product information, a demand prediction value, a demand result value, and a distribution result value related to the product. Therefore, according to the information processing system 1A, in addition to the effects provided by the information processing system 1, it is possible to obtain an effect that it is possible to present, to the user, the interpretation example in consideration of some or all of the product information, the demand prediction value, the demand result value, and the distribution result value related to the product, for the error of the demand prediction indicated by the product-specific indices.

The information processing system 1A also adopts the configuration in which the extra-company information includes some or all of a change in regulations in an industry related to the product and information indicating an external environment of the industry. Therefore, according to the information processing system 1A, in addition to the effects provided by the information processing system 1, it is possible to obtain an effect that it is possible to present, to the user, the interpretation example in consideration of some or all of the change in the regulations in the industry related to the product and the information indicating the external environment of the industry, for the error of the demand prediction indicated by the product-specific indices.

The demand prediction has an error from results due to various factors. Therefore, it is important to analyze the error of the demand prediction for each product. However, JP 2015-118412 A does not describe analyzing the error of the demand prediction. There is a problem that specialized knowledge is needed for analysis of such an error of the demand prediction. Even in the case of having the specialized knowledge, the analysis of such an error of the demand prediction has problems that information to be considered may be missing, it takes time to collect and organize information, it may be difficult to take sufficient consideration time, and the like.

Therefore, there is demand for a technology of supporting the analysis of the error of the demand prediction for each product.

The present disclosure has been made in view of the above problems.

According to an exemplary aspect of the present disclosure, there is provided an exemplary effect that a technology of supporting analysis of an error of demand prediction for each product can be provided.

### (Achievement Example by Software)

Some or all of the functions of the information processing system 1, the information processing device 10, and the user terminal 20 (hereinafter, also described as “each of the above devices”) may be achieved by hardware such as an integrated circuit (IC chip) or may be achieved by software.

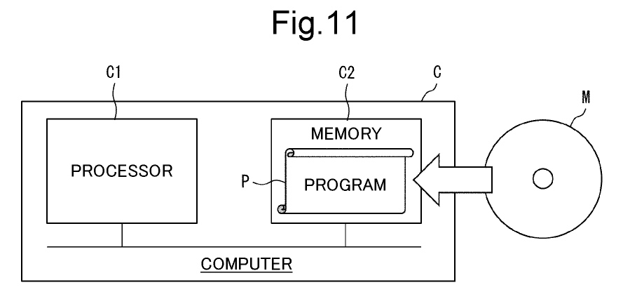

In the latter case, each of the above devices is achieved by, for example, a computer that executes a command of a program as software for achieving each function. An example of such a computer (hereinafter, described as a computer C) is illustrated in FIG. 11. FIG. 11 is a block diagram illustrating a hardware configuration of the computer C functioning as each of the above devices.

The computer C includes at least one processor C1 and at least one memory C2. A program P causing the computer C to operate as each of the above devices is recorded in the memory C2. In the computer C, by the processor C1 reading the program P from the memory C2 and executing the program P, each function of each of the above devices is achieved.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, or a programmable logic circuit can be used.

The computer C can acquire the program P via such a recording medium M. The program P can be transmitted via a transmission medium. As such a transmission medium, for example, a communication network or a broadcast wave can be used. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in a plurality of computers.

### [Supplementary Note A]

The present disclosure includes technologies described in the following Supplementary Notes. However, the present disclosure is not limited to the technologies described in the following Supplementary Notes, and various modifications can be made within the scope described in the claims.

### (Supplementary Note A1)

An information processing system including: index acquisition means for acquiring product-specific indices for managing accuracy of demand prediction related to a product handled by an object company;

intra-company information acquisition means for acquiring intra-company information related to the product inside the object company;

extra-company information acquisition means for acquiring extra-company information related to the product outside the object company; and

interpretation example generation means for generating, as an interpretation example of the product-specific indices, a sentence including an interpretation example based on the intra-company information and the extra-company information, by using a large language model.

### (Supplementary Note A2)

The information processing system according to Supplementary Note A1, in which the interpretation example includes some or all of a situation of an error of demand prediction related to the product, a factor based on the intra-company information and the extra-company information related to the error of the demand prediction, and a proposal for a response to the error of the demand prediction.

### (Supplementary Note A3)

The information processing system according to Supplementary Note A1 or A2, in which

the index acquisition means acquires the product-specific indices for each of a plurality of products, and

the interpretation example includes an interpretation example of an index that satisfies a predetermined alert condition among the product-specific indices for each of the plurality of products.

### (Supplementary Note A4)

The information processing system according to Supplementary Note A3, further including:

first display control means for displaying, on a display device, a first screen including the product-specific indices for each of the plurality of products and the interpretation example of the product-specific index that satisfies the alert condition; and

second display control means for displaying, according to an operation for specifying any one of the plurality of products included in the first screen, a second screen including the product-specific indices related to the specified product and the interpretation example of the product-specific indices, on the display device.

### (Supplementary Note A5)

The information processing system according to any one of Supplementary Notes A1 to A4, in which the intra-company information includes one or both of promotion information in an object company related to the product and sales information of another product in the object company in the same category as the product.

### (Supplementary Note A6)

The information processing system according to any one of Supplementary Notes A1 to A5, in which the extra-company information includes some or all of release of a new product of a competing brand of the product, trend information of the competing brand, and trend information of a market to which the product belongs.

### (Supplementary Note A7)

The information processing system according to any one of Supplementary Notes A1 to A6, in which the intra-company information includes some or all of product information, a demand prediction value, a demand result value, and a distribution result value related to the product.

### (Supplementary Note A8)

The information processing system according to any one of Supplementary Notes A1 to A7, in which the extra-company information includes some or all of a change in regulations in an industry related to the product and information indicating an external environment of the industry.

### [Supplementary Note B]

The present disclosure includes technologies described in the following Supplementary Notes. However, the present disclosure is not limited to the technologies described in the following Supplementary Notes, and various modifications can be made within the scope described in the claims.

### (Supplementary Note B1)

An information processing method including:

index acquisition processing in which at least one processor acquires product-specific indices for managing accuracy of demand prediction related to a product handled by an object company;

intra-company information acquisition processing in which the at least one processor acquires intra-company information related to the product inside the object company;

extra-company information acquisition processing in which the at least one processor acquires extra-company information related to the product outside the object company; and

interpretation example generation processing in which the at least one processor generates, as an interpretation example of the product-specific indices, a sentence including an interpretation example based on the intra-company information and the extra-company information, by using a large language model.

### (Supplementary Note B2)

The information processing method according to Supplementary Note B1, in which the interpretation example includes some or all of a situation of an error of demand prediction related to the product, a factor based on the intra-company information and the extra-company information related to the error of the demand prediction, and a proposal for a response to the error of the demand prediction.

### (Supplementary Note B3)

The information processing method according to Supplementary Note B1 or B2, in which

in the index acquisition processing, the at least one processor acquires the product-specific indices for each of a plurality of products, and

the interpretation example includes an interpretation example of an index that satisfies a predetermined alert condition among the product-specific indices for each of the plurality of products.

### (Supplementary Note B4)

The information processing method according to Supplementary Note B3, further including:

first display control processing in which the at least one processor displays, on a display device, a first screen including the product-specific indices for each of the plurality of products and the interpretation example of the product-specific index that satisfies the alert condition; and

second display control processing in which the at least one processor displays, according to an operation for specifying any one of the plurality of products included in the first screen, a second screen including the product-specific indices related to the specified product and the interpretation example of the product-specific indices, on the display device.

### (Supplementary Note B5)

The information processing method according to any one of Supplementary Notes B1 to B4, in which the intra-company information includes one or both of promotion information in an object company related to the product and sales information of another product in the object company in the same category as the product.

### (Supplementary Note B6)

The information processing method according to any one of Supplementary Notes B1 to B5, in which the extra-company information includes some or all of release of a new product of a competing brand of the product, trend information of the competing brand, and trend information of a market to which the product belongs.

(Supplementary Note B7)

The information processing method according to any one of Supplementary Notes B1 to B6, in which the intra-company information includes some or all of product information, a demand prediction value, a demand result value, and a distribution result value related to the product.

### (Supplementary Note B8)

The information processing method according to any one of Supplementary Notes B1 to B7, in which the extra-company information includes some or all of a change in regulations in an industry related to the product and information indicating an external environment of the industry.

### [Supplementary Note C]

The present disclosure includes technologies described in the following Supplementary Notes. However, the present disclosure is not limited to the technologies described in the following Supplementary Notes, and various modifications can be made within the scope described in the claims.

### (Supplementary Note C1)

An information processing program for causing a computer to function as an information processing system, the computer being caused to function as:

index acquisition means for acquiring product-specific indices for managing accuracy of demand prediction related to a product handled by an object company;

intra-company information acquisition means for acquiring intra-company information related to the product inside the object company;

extra-company information acquisition means for acquiring extra-company information related to the product outside the object company; and

interpretation example generation means for generating, as an interpretation example of the product-specific indices, a sentence including an interpretation example based on the intra-company information and the extra-company information, by using a large language model.

### (Supplementary Note C2)

The information processing program according to Supplementary Note C1, in which the interpretation example includes some or all of a situation of an error of demand prediction related to the product, a factor based on the intra-company information and the extra-company information related to the error of the demand prediction, and a proposal for a response to the error of the demand prediction.

### (Supplementary Note C3)

The information processing program according to Supplementary Note C1 or C2, in which

the index acquisition means acquires the product-specific indices for each of a plurality of products, and

the interpretation example includes an interpretation example of an index that satisfies a predetermined alert condition among the product-specific indices for each of the plurality of products.

### (Supplementary Note C4)

The information processing program according to Supplementary Note C3, further causing the computer to function as:

first display control means for displaying, on a display device, a first screen including the product-specific indices for each of the plurality of products and the interpretation example of the product-specific index that satisfies the alert condition; and

second display control means for displaying, according to an operation for specifying any one of the plurality of products included in the first screen, a second screen including the product-specific indices related to the specified product and the interpretation example of the product-specific indices, on the display device.

### (Supplementary Note C5)

The information processing program according to any one of Supplementary Notes C1 to C4, in which the intra-company information includes one or both of promotion information in an object company related to the product and sales information of another product in the object company in the same category as the product.

### (Supplementary Note C6)

The information processing program according to any one of Supplementary Notes C1 to C5, in which the extra-company information includes some or all of release of a new product of a competing brand of the product, trend information of the competing brand, and trend information of a market to which the product belongs.

### (Supplementary Note C7)

The information processing program according to any one of Supplementary Notes C1 to C6, in which the intra-company information includes some or all of product information, a demand prediction value, a demand result value, and a distribution result value related to the product.

### (Supplementary Note C8)

The information processing program according to any one of Supplementary Notes C1 to C7, in which the extra-company information includes some or all of a change in regulations in an industry related to the product and information indicating an external environment of the industry.

### [Supplementary Note D]

The present disclosure includes technologies described in the following Supplementary Notes. However, the present disclosure is not limited to the technologies described in the following Supplementary Notes, and various modifications can be made within the scope described in the claims.

### (Supplementary Note D1)

An information processing system including at least one processor, the at least one processor executing:

index acquisition processing of acquiring product-specific indices for managing accuracy of demand prediction related to a product handled by an object company;

intra-company information acquisition processing of acquiring intra-company information related to the product inside the object company;

extra-company information acquisition processing of acquiring extra-company information related to the product outside the object company; and

interpretation example generation processing of generating, as an interpretation example of the product-specific indices, a sentence including an interpretation example based on the intra-company information and the extra-company information, by using a large language model.

The information processing system may further include a memory. The memory may store a program for causing the at least one processor to execute each of the processing.

### (Supplementary Note D2)

The information processing system according to Supplementary Note D1, in which the interpretation example includes some or all of a situation of an error of demand prediction related to the product, a factor based on the intra-company information and the extra-company information related to the error of the demand prediction, and a proposal for a response to the error of the demand prediction.

### (Supplementary Note D3)

The information processing system according to Supplementary Note D1 or D2, in which

in the index acquisition processing, the at least one processor acquires the product-specific indices for each of a plurality of products, and

the interpretation example includes an interpretation example of an index that satisfies a predetermined alert condition among the product-specific indices for each of the plurality of products.

### (Supplementary Note D4)

The information processing system according to Supplementary Note D3, in which the at least one processor further executes:

first display control processing of displaying, on a display device, a first screen including the product-specific indices for each of the plurality of products and the interpretation example of the product-specific index that satisfies the alert condition; and

second display control processing of displaying, according to an operation for specifying any one of the plurality of products included in the first screen, a second screen including the product-specific indices related to the specified product and the interpretation example of the product-specific indices, on the display device.

### (Supplementary Note D5)

The information processing system according to any one of Supplementary Notes D1 to D4, in which the intra-company information includes one or both of promotion information in an object company related to the product and sales information of another product in the object company in the same category as the product.

### (Supplementary Note D6)

The information processing system according to any one of Supplementary Notes D1 to D5, in which the extra-company information includes some or all of release of a new product of a competing brand of the product, trend information of the competing brand, and trend information of a market to which the product belongs.

### (Supplementary Note D7)

The information processing system according to any one of Supplementary Notes D1 to D6, in which the intra-company information includes some or all of product information, a demand prediction value, a demand result value, and a distribution result value related to the product.

### (Supplementary Note D8)

The information processing system according to any one of Supplementary Notes D1 to D7, in which the extra-company information includes some or all of a change in regulations in an industry related to the product and information indicating an external environment of the industry.

### [Supplementary Note E]

The present disclosure includes technologies described in the following Supplementary Notes. However, the present disclosure is not limited to the technologies described in the following Supplementary Notes, and various modifications can be made within the scope described in the claims.

### (Supplementary Note E1)

A non-transitory recording medium recording an information processing program for causing a computer to function as an information processing system, the computer being caused to execute:

index acquisition processing of acquiring product-specific indices for managing accuracy of demand prediction related to a product handled by an object company;

intra-company information acquisition processing of acquiring intra-company information related to the product inside the object company;

extra-company information acquisition processing of acquiring extra-company information related to the product outside the object company; and

interpretation example generation processing of generating, as an interpretation example of the product-specific indices, a sentence including an interpretation example based on the intra-company information and the extra-company information, by using a large language model.

1. An information processing system comprising:
one or more memories storing instructions; and
one or more processors configured to execute the instructions to:
acquire product-specific indices for managing accuracy of demand prediction related to a product handled by an object company;
acquire intra-company information related to the product inside the object company;
acquire extra-company information related to the product outside the object company; and
generate, as an interpretation example of the product-specific indices, a sentence including an interpretation example based on the intra-company information and the extra-company information, by using a large language model.

2. The information processing system according to claim 1, wherein the interpretation example includes some or all of a situation of an error of demand prediction related to the product, a factor based on the intra-company information and the extra-company information related to the error of the demand prediction, and a proposal for a response to the error of the demand prediction.

3. The information processing system according to claim 1, wherein the one or more processors are configured to execute the instructions to acquire the product-specific indices for each of a plurality of products, and
the interpretation example includes an interpretation example of an index that satisfies a predetermined alert condition among the product-specific indices for each of the plurality of products.

4. The information processing system according to claim 3, wherein the one or more processors are further configured to execute the instructions to:
display, on a display device, a first screen including the product-specific indices for each of the plurality of products and the interpretation example of the product-specific index that satisfies the alert condition; and
display, according to an operation for specifying any one of the plurality of products included in the first screen, a second screen including the product-specific indices related to the specified product and the interpretation example of the product-specific indices, on the display device.

5. The information processing system according to claim 1, wherein the intra-company information includes one or both of promotion information in an object company related to the product and sales information of another product in the object company in a same category as the product.

6. The information processing system according to claim 1, wherein the extra-company information includes some or all of release of a new product of a competing brand of the product, trend information of the competing brand, and trend information of a market to which the product belongs.

7. The information processing system according to claim 1, wherein the intra-company information includes some or all of product information, a demand prediction value, a demand result value, and a distribution result value related to the product.

8. The information processing system according to claim 1, wherein the extra-company information includes some or all of a change in regulations in an industry related to the product and information indicating an external environment of the industry.

9. The information processing system according to claim 1, wherein the large language model is a deep learning model trained to support decision making by analyzing an error of demand prediction and providing interpretation examples that facilitate business decisions.

10. An information processing method comprising:
acquiring product-specific indices for managing accuracy of demand prediction related to a product handled by an object company;
acquiring intra-company information related to the product inside the object company;
acquiring extra-company information related to the product outside the object company; and
generating, as an interpretation example of the product-specific indices, a sentence including an interpretation example based on the intra-company information and the extra-company information, by using a large language model.

11. A non-transitory recording medium recording an information processing program for causing at least one processor to execute:
acquiring product-specific indices for managing accuracy of demand prediction related to a product handled by an object company;
acquiring intra-company information related to the product inside the object company;
acquiring extra-company information related to the product outside the object company; and
generating, as an interpretation example of the product-specific indices, a sentence including an interpretation example based on the intra-company information and the extra-company information, by using a large language model.
